(19) United States
(12) Patent Application Publication
(10) Pub. No.: US 2026/0307991 A1
(43) Pub. Date: Oct. 8, 2026

(54) METHOD FOR PRODUCING LITHIUM SULFIDE FOR SOLID ELECTROLYTE

(71) Applicant: SK On Co., Ltd., Seoul (KR)

(72) Inventors: Ji Su BACK, Daejeon (KR); Je Hoon WOO, Daejeon (KR)

(21) Appl. No.: 19/460,327

(22) Filed: Jan. 27, 2026

(30) Foreign Application Priority Data
Feb. 10, 2025 (KR) 10-2025-0016839

(51) Int. Cl. C01B 17/40; H01M 10/0562

(52) U.S. Cl. CPC C01B 17/40; H01M 10/0562; C01P 2002/72; C01P 2006/40; H01M 2300/0068

(57) ABSTRACT

A method for producing lithium sulfide for a solid electrolyte includes mixing a lithium supply material and a sulfur supply material in a solvent to synthesize lithium sulfide; drying the solvent to obtain lithium sulfide, wrapping the dried lithium sulfide with a heat transfer material, and heat-treating the lithium sulfide wrapped with the heat transfer material by applying microwaves.

### CROSS-REFERENCE TO RELATED APPLICATION(S)

This patent document claims the priority and benefits of Korean Patent Application No. 10-2025-0016839 filed on Feb. 10, 2025, the disclosure of which is incorporated herein by reference in its entirety.

### TECHNICAL FIELD

The disclosure and implementations disclosed in this patent document generally relate to a method for producing lithium sulfide for a solid electrolyte.

### BACKGROUND

Recently, development of all-solid-state batteries including solid electrolytes has been continuously progressing. All-solid-state batteries, including solid electrolytes, instead of existing liquid electrolytes, may offer superior safety against explosions or fires and enhanced energy density. Solid electrolytes applicable to all-solid-state batteries include polymer-based solid electrolytes, oxide-based solid electrolytes, and sulfide-based solid electrolytes.

Thereamong, sulfide-based solid electrolytes have relatively high ionic conductivity and have come to prominence as electrolytes with high potential for commercialization. Therefore, there is a growing demand for the development of technologies capable of efficiently producing lithium sulfide necessary for producing sulfide-based solid electrolytes.

### SUMMARY

The present disclosure may be implemented in some embodiments to provide a method for efficiently producing lithium sulfide is provided by reducing the production time thereof.

The present disclosure may also be implemented in some embodiments to provide a method for producing lithium sulfide with high crystallinity.

The present disclosure may also be implemented in some embodiments to provide a method for producing high-purity lithium sulfide.

In some embodiments of the present disclosure, a method for producing lithium sulfide for a solid electrolyte includes: mixing a lithium supply material and a sulfur supply material in a solvent to synthesize lithium sulfide; drying the solvent to obtain lithium sulfide; wrapping the dried lithium sulfide with a heat transfer material; and heat-treating lithium sulfide wrapped with the heat transfer material by applying microwaves.

The lithium supply material may include at least one selected from the group consisting of lithium metal, lithium alkoxide, and lithium halide.

The sulfur supply material may include at least one selected from the group consisting of sulfur (S), hydrogen sulfide (H₂S), and metal sulfide represented by Chemical Formula 1 below:

MₓS [Chemical Formula 1]
where M is at least one metal element selected from the group consisting of group 1 elements and group 2 elements, S is sulfur, and x is 1 or 2.

The solvent may include at least one selected from the group consisting of an alcohol solvent and an ether solvent.

The drying of the solvent may be performed at a temperature of 80° C. to 200° C.

The heat transfer material may include at least one selected from the group consisting of a carbon material and a carbide material.

The carbon material may include at least one selected from the group consisting of graphite, carbon black, graphene, and carbon nanotube.

The carbide material may include at least one selected from the group consisting of silicon carbide and titanium carbide.

The wrapping of the dried lithium sulfide with the heat transfer material may include introducing the dried lithium sulfide into a container including the heat transfer material.

The wrapping of the dried lithium sulfide with the heat transfer material may include: pelletizing the dried lithium sulfide; and covering the pelletized lithium sulfide with the heat transfer material.

The heat-treating may be performed at a temperature of 300° C. to 900° C.

The heat-treating may be performed for 5 to 30 minutes.

### BRIEF DESCRIPTION OF DRAWINGS

Certain aspects, features, and advantages of the present disclosure are illustrated by the following detailed description with reference to the accompanying drawings.

FIG. 1A is a graph illustrating XRD analysis results of lithium sulfide according to Example 1.

FIG. 1B is a graph illustrating the XRD analysis results of lithium sulfide according to Comparative Example 1.

FIG. 1C is a graph illustrating the XRD analysis results of lithium sulfide according to Comparative Example 2.

### DETAILED DESCRIPTION

Hereinafter, the technology disclosed in the present specification and embodiments thereof are described in detail. However, the embodiments of the technology may be modified in various other forms, and the scope is not limited to the embodiments described below. In addition, the technology disclosed in this specification is not only limited the specific components of the embodiments described below but may also be configured by selectively combining all or some of the embodiments to allow for various modifications.

As described hereinabove, there is a need for the development of a technology capable of efficiently manufacturing lithium sulfide necessary for producing sulfide-based solid electrolytes. In particular, a wet synthesis method, which synthesizes lithium sulfide in the presence of a solvent, may produce lithium sulfide with a small particle size. In addition, the particle size may be easily increased after making it highly suitable for mass-production of lithium sulfide suitable for specific applications.

According to an embodiment, after synthesizing lithium sulfide in the presence of a solvent, heat treatment may be performed in a furnace to enhance crystallinity. However, in the case of this manufacturing method, a large amount of impurities may be introduced due to the carbonization of the solvent during the heat treatment process, which may reduce the purity of the lithium sulfide. In addition, heat treatment in a furnace requires significant time for temperature increase and the heat treatment, which may pose limitations for mass production.

In contrast, in the method for producing lithium sulfide for a solid electrolyte according to an embodiment of the present disclosure, lithium sulfide may be synthesized in the presence of a solvent and then dried, and the dried lithium may be heat-treated using a microwave. Therefore, carbonization of the solvent rarely occurs during the heat treatment, resulting in relatively low impurities and high purity of the lithium sulfide. In addition, since heat treatment is performed using microwaves, which rapidly raise the temperature, highly crystalline lithium sulfide may be produced within a short period of time.

Specifically, the method for producing lithium sulfide for a solid electrolyte according to an embodiment of the present disclosure may include synthesizing lithium sulfide by mixing a lithium supply material and a sulfur supply material in a solvent; drying the solvent to obtain lithium sulfide; wrapping the dried lithium sulfide with a heat transfer material; and heat-treating the lithium sulfide wrapped with the heat transfer material using microwaves. Hereinafter, respective operations in the method for producing lithium sulfide for a solid electrolyte according to the present disclosure will be described in detail.

### Method for Producing Lithium Sulfide for Solid Electrolyte

### <Lithium Sulfide Synthesis Operation>

A method for producing lithium sulfide according to an embodiment of the present disclosure may include an operation of synthesizing lithium sulfide by mixing a lithium supply material and a sulfur supply material in a solvent.

The lithium supply material is not limited as long as it may react with the sulfur supply material to synthesize lithium sulfide. For example, the lithium supply material may include at least one selected from the group consisting of lithium metal, lithium alkoxide, and lithium halide. More specifically, the lithium supply material may be lithium metal, lithium methoxide, lithium ethoxide, LiCl, LiBr, or LiI.

The sulfur supply material is not limited as long as it may react with the lithium supply material to synthesize lithium sulfide. For example, the sulfur supply material may include at least one selected from the group consisting of sulfur (S), hydrogen sulfide (H₂S), and a metal sulfide represented by the Chemical Formula 1 below.

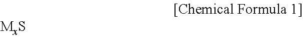

In Chemical Formula 1, M is at least one metal element selected from the group consisting of group 1 and group 2 elements, S is sulfur, and x is 1 or 2.

More specifically, the sulfur supply material may be sulfur (S), hydrogen sulfide (H₂S), Na₂S, K2S, MgS, or CaS.

The solvent is not limited as long as it may dissolve the lithium supply material or the sulfur supply material to enable the synthesis of lithium sulfide. The solvent may be an organic solvent. For example, the solvent may include at least one selected from the group consisting of alcohol-based solvents, ether-based solvents, and tetrahydrofuran-based solvents.

The alcohol-based solvent is not particularly limited as long as it is an alcohol compound including a hydroxyl group (—OH). For example, the alcohol-based solvent may be methanol, ethanol, isopropanol, etc.

The ether-based solvent is not particularly limited as long as it is a compound having a structure (R—O—R′) including an oxygen atom between alkyl groups. For example, the ether-based solvent may be dimethyl ether, diethyl ether, ethylmethyl ether, etc.

The tetrahydrofuran-based solvent is not particularly limited as long as it is a compound having a pentagonal heterocycle in which four carbon atoms and an oxygen atom are connected by a single bond. For example, the tetrahydrofuran-based solvent may be one or more selected from tetrahydrofuran; and a compound having at least one functional group bonded to the second or third carbon atom of tetrahydrofuran. For example, the compound having at least one functional group bonded to the second or third carbon atom of tetrahydrofuran may be 2-methyltetrahydrofuran, 3-methyltetrahydrofuran, 2-(isocyanomethyl)tetrahydrofuran, 3-(aminomethyl)tetrahydrofuran, etc.

The method for synthesizing lithium sulfide may be a wet synthesis method including a process of mixing the lithium supply material and the sulfur supply material in a solvent phase. The specific synthesis method is not limited.

For example, the method for synthesizing lithium sulfide may include preparing a lithium metal solution by dissolving lithium metal in an ether solvent and adding sulfur (S) to the lithium metal solution to cause a reaction in a suspension state. As another example, the method for synthesizing the lithium sulfide may include dissolving a lithium alkoxide, such as lithium ethoxide, as a lithium supply material in an alcohol-based solvent, and then reacting it by bubbling hydrogen sulfide (H₂S) gas as a sulfur supply material. As another example, the method for synthesizing lithium sulfide may include dissolving a lithium halide, such as LiCl, as a lithium supply material and a metal sulfide, such as Na₂S, as a sulfur supply material in an alcoholic solvent and reacting them.

When lithium sulfide is synthesized using the wet synthesis method described hereinabove, amorphous lithium sulfide with low crystallinity may be obtained immediately after synthesis. In the method for producing lithium sulfide according to the present disclosure, even though lithium sulfide is synthesized using the wet synthesis method, lithium sulfide with high purity and crystallinity may be produced within a short period of time by drying and then heat-treating with microwaves, as described below.

### <Operation of Obtaining Lithium Sulfide>

The method of producing lithium sulfide according to an embodiment of the present disclosure may include an operation of drying a solvent to obtain lithium sulfide. The operation of obtaining lithium sulfide may be an operation of obtaining lithium sulfide synthesized in the lithium sulfide synthesis operation in solid form and may be performed by removing the solvent through drying. If the solvent is not dried in the lithium sulfide synthesized by the wet synthesis method or heat treatment is performed simultaneously with drying, carbonization of the organic solvent may occur at high temperatures, resulting in the final lithium sulfide including a large amount of impurities. In the method of producing lithium sulfide according to the present disclosure, lithium sulfide may be synthesized in the presence of a solvent and the solvent is dried prior to heat treatment, thereby producing high-purity lithium sulfide.

The process of drying the solvent may be performed at a temperature equal to or higher than a boiling point of the solvent in use, at which the solvent may be removed. In some embodiments, the solvent drying may be performed at a temperature of 80 to 200° C. For example, the solvent drying may be performed at a temperature of 100 to 180° C. or 120 to 160° C. If the solvent drying is performed at a temperature lower than 80° C., the solvent removal rate may be slow to reducing productivity or the solvent may not be sufficiently removed to result in the final lithium sulfide including a large amount of impurities. If the solvent drying is performed at a temperature higher than 200° C., the excessively high temperature may cause carbonization of the solvent, resulting in the final lithium sulfide including a large amount of impurities, including carbon.

In some embodiments, the operation of obtaining lithium sulfide may further include removing precipitates formed during the operation of synthesizing lithium sulfide before drying the solvent. By removing the formed precipitates before drying the solvent, the purity of the finally produced lithium sulfide may be increased. For example, the formed precipitates may be a compound represented by Chemical Formula 2 below:

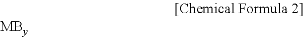

In Chemical Formula 2, A is at least one metal element selected from the group consisting of group 1 elements and group 2 elements, B is at least one element selected from the group consisting of Cl, Br, and I, and y is 1 or 2.

The compound represented by Chemical Formula 2 may be removed from the solution by centrifugation. In addition, the compound represented by Chemical Formula 2 may be removed from the solution by filtering the solution through a microfilter.

<Operation of Wrapping Lithium Sulfide with Heat Transfer Material>

The method for producing lithium sulfide for solid electrolyte according to an embodiment of the present disclosure may include an operation of wrapping dried lithium sulfide with a heat transfer material. The lithium sulfide obtained by drying the solvent in the operation of obtaining lithium sulfide may include a large amount of amorphous lithium sulfide, resulting in low crystallinity. Therefore, the method for producing lithium sulfide according to the present disclosure may increase the crystallinity of lithium sulfide by applying microwaves during the heat treatment operation to be described below to perform heat treatment at high temperatures within a short period of time. Meanwhile, if microwaves are directly applied to lithium sulfide in a dried solid state, it may be difficult to increase the crystallinity because the temperature rise resulting from microwave absorption is not significant.

Therefore, the method for producing lithium sulfide according to the present disclosure may include an operation of wrapping the obtained lithium sulfide with a heat transfer material before applying microwaves for heat treatment. The heat transfer material may absorb microwaves to be rapidly heated to high temperatures. The heat transfer material, heated to a high temperatures within a short period of time, may transfer heat to lithium sulfide, thereby effectively increasing the crystallinity of the lithium sulfide.

The heat transfer material is not particularly limited as long as it absorbs microwaves to be heated to high temperatures within a short period of time and transfers heat to lithium sulfide. For example, the heat transfer material may include at least one selected from the group consisting of a carbon material and a carbide material. When the heat transfer material includes the above materials, the heat transfer material may absorb microwaves and be heated to high temperatures of about 1000° C. or higher within about 1 minute. Therefore, heat may be transferred from the heat transfer material to lithium sulfide, thereby rapidly and effectively increasing the crystallinity of lithium sulfide.

For example, the carbon material may include at least one selected from the group consisting of graphite, carbon black, graphene, and carbon nanotubes. When the heat transfer material includes the aforementioned type of carbon material, it may rapidly absorb microwaves so as to be heated, thereby rapidly and effectively increasing the crystallinity of lithium sulfide.

For example, the carbide material may include at least one selected from the group consisting of silicon carbide and titanium carbide. When the heat transfer material includes the aforementioned type of carbide material, the heat transfer material may absorb microwaves so as to be rapidly heated, thereby rapidly and effectively increasing the crystallinity of lithium sulfide.

The method of wrapping lithium sulfide with the heat transfer material is not limited, as long as the heat transfer material is of a form capable of effectively transferring heat to the lithium sulfide. In some embodiments, the operation of wrapping the dried lithium sulfide with the heat transfer material may include introducing the dried lithium sulfide into a container including the heat transfer material. For example, the container may be a crucible formed of a material including at least one selected from the group consisting of the carbon material and the carbide material, and the dried lithium sulfide may be introduced into the crucible formed of the aforementioned material.

In some other embodiments, the operation of wrapping the dried lithium sulfide with a heat transfer material may include an operation of pelletizing the dried lithium sulfide and an operation of covering the pelletized lithium sulfide with the heat transfer material. For example, the operation of wrapping the dried lithium sulfide with the heat transfer material may include compressing the dried lithium sulfide under a predetermined pressure to form a pellet and then covering the pelletized lithium sulfide with powder including at least one selected from the group consisting of the carbon material and the carbide material.

As described hereinabove, after wrapping the dried lithium sulfide with the heat transfer material, it may be placed inside a microwave application device. The operation of applying microwaves to perform heat treatment will now be described in detail.

### <Heat Treatment Operation>

The method for manufacturing lithium sulfide according to the present disclosure may include an operation of heat-treating lithium sulfide covered with the heat transfer material by applying microwaves. The microwaves may be applied through a microwave device in the heat treatment operation. As described hereinabove, lithium sulfide synthesized in a solvent and then dried may include a large amount of amorphous lithium sulfide, resulting in low crystallinity. In the case of producing a sulfide-based solid electrolyte using lithium sulfide with low crystallinity, the crystallinity of the sulfide-based solid electrolyte may also be low, resulting in poor ionic conductivity and lifespan characteristics.

Heat-treating lithium sulfide using microwaves allows for temperature increase to high temperatures within a short period of time, enabling efficient and economical production of lithium sulfide. When heat-treating lithium sulfide in a furnace, it may be difficult to increase the temperature to very high temperatures and it may take a considerable amount of time. In contrast, heat treating lithium sulfide using microwaves may raise the temperature to approximately 1,000° C. within a short period of time. In addition, the method for producing lithium sulfide according to the present disclosure includes an operation of drying and removing the solvent and wrapping the lithium sulfide with a heat transfer material, as described hereinabove, and therefore, high-purity, high-crystalline lithium sulfide may be effectively produced within a short period of time by applying microwaves and performing heat treatment.

The heat treatment operation may be performed at a temperature at which the crystallinity of the lithium sulfide can be sufficiently increased. For example, the heat treatment operation may be performed at 300 to 900° C. More specifically, the heat treatment operation may be performed at 400 to 800° C. or 500 to 700° C. If the heat treatment operation is performed at a temperature lower than 300° C., the crystallinity of the lithium sulfide may not be sufficiently increased, which may result in poor ionic conductivity and lifespan characteristics when producing a sulfide-based solid electrolyte. If the heat treatment operation is performed at a temperature exceeding 900° C., the temperature may approach a melting point of lithium sulfide, resulting in melting of the lithium sulfide due to excessive heating.

The heat treatment operation may be performed for a period of time sufficient to sufficiently increase the crystallinity of lithium sulfide. For example, the heat treatment operation may be performed for 5 to 30 minutes. If the heat treatment operation is performed for less than 5 minutes, the crystallinity of the lithium sulfide may not sufficiently increase, resulting in poor ionic conductivity and lifespan characteristics when manufacturing a sulfide-based solid electrolyte. If the heat treatment operation is performed for more than 30 minutes, the carbonization of the residual solvent may increase the impurity content in the final lithium sulfide.

The heat treatment operation may be performed in an argon (Ar) environment or in a vacuum state.

During the heat treatment operation, microwaves may be applied at a power of 0.1 to 2.8 kW. By controlling the microwave power within the above range, the crystallinity of lithium sulfide may be effectively increased. If the microwave power is less than 0.1 kW, lithium sulfide may not be heat-treated at a sufficiently high temperature, resulting in low crystallinity. If the microwave power exceeds 2.8 kW, excessive heating may cause lithium sulfide to melt and malfunction of heat treatment equipment.

During the heat treatment operation, microwaves may be applied at a frequency of 2.425 to 2.475 GHz. By controlling the microwave frequency within the above range, the heat transfer material may absorb the microwaves and be rapidly heated to a higher temperature, thereby effectively increasing the crystallinity of lithium sulfide.

### Lithium Sulfide for a Solid Electrolyte

Lithium sulfide for a solid electrolyte according to an embodiment of the present disclosure may have a crystallinity of 85% or greater according to a Rietveld refinement method when analyzed by X-ray diffraction (XRD). For example, the lithium sulfide for a solid electrolyte according to an embodiment may have a crystallinity of 96% or greater according to the Rietveld refinement method when analyzed by X-ray diffraction (XRD). The Rietveld refinement method allows for the simultaneous analysis of the entire diffraction pattern derived from XRD analysis of a target object without the need to separate individual peaks. Therefore, more accurate crystallographic analysis results may be derived during analysis by the Rietveld refinement method, enabling a more precise evaluation of differences in chemical properties resulting from a composition and crystal structure of the target to be measured. The X-ray diffraction (XRD) analysis equipment and conditions are not particularly limited.

Lithium sulfide produced by the method for producing lithium sulfide according to the present disclosure has high crystallinity within the above range, thereby enabling high ionic conductivity and lifespan characteristics when subsequently used to produce a sulfide-based solid electrolyte.

### Sulfide-Based Solid Electrolyte and Production Method Thereof

A method for producing a sulfide-based solid electrolyte according to an embodiment may include an operation of producing lithium sulfide using the method of producing lithium sulfide according to any one of the above-described embodiments; an operation of mixing the produced lithium sulfide with phosphorus pentasulfide (P₂S₅) and lithium halide in an organic solvent to form a mixture; and an operation of drying and heat-treating the mixture to obtain a sulfide-based solid electrolyte.

The produced sulfide-based solid electrolyte may be at least one selected from among Li₂S—P₂S₅, Li₂S—P₂S₅—LiX (X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m, n are positive numbers, and Z is one of Ge, Zn, or Ga), Li₂S—GeS₂, Li₂S—SiS₂—Li₃PO₄, Li₂S—SiS₂-LiₚMO_{q} (p, q are positive numbers, M is one of P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

The sulfide-based solid electrolyte may be an argyrodite-based solid electrolyte. The argyrodite-based solid electrolyte may be a compound represented by Chemical Formula 3 below.

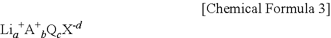

In Chemical Formula 4, 1≤a≤12, 0≤b≤5, 0≤c≤10, and 0≤d≤2, A is at least one of P, As, Ge, Ga, Sb, Si, Sn, Al, In, Ti, V, Nb, or Ta, Q is at least one of S, Se, or Te, and X is at least one of Cl, Br, I, F, CN, OCN, SCN, or N₃.

Specifically, the argyrodite-based solid electrolyte may be a compound represented by chemical formulas, such as Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), Li₆PS₅Cl, Li₆PS₅Br, Li₆PS₅I, Li_{6.5}Sb_{0.5}Ge_{0.5}S₅I, Li_{5.7}PS_{4.7}Cl_{1.3}, Li_{6.6}Sb_{0.5}Si_{0.6}S₅I, or the like.

### EXAMPLES

Hereinafter, examples of the present disclosure are additionally described with reference to specific experimental examples. The examples and comparative examples included in the experimental examples are merely illustrative of the present disclosure and do not limit the scope of the appended claims, and it will be apparent to those skilled in the art that various modifications and variations of the examples may be made within the scope and technical spirit of the present disclosure, and it is natural that such modifications and variations fall within the scope of the appended claims.

### 1. Preparation of Lithium Sulfide (Li₂S)

### (1) Example 1

Sodium sulfide (Na₂S) and lithium chloride (LiCl), weighed at a molar ratio of 1:2, were prepared as a sulfur supply material and a lithium supply material. The sodium sulfide (Na₂S) and lithium chloride (LiCl) were mixed with ethanol as a solvent at approximately 50° C. to produce a solution with a concentration of approximately 0.3 M. The solution was stirred with a magnetic stirrer to conduct a synthesis reaction of lithium sulfide (Li₂S) and precipitated sodium chloride (NaCl) was then filtered and removed. The solution was then dried at 80° C. or higher so as to be removed to obtain lithium sulfide (Li₂S) in a solid powder form. 5 g of the obtained powder-type lithium sulfide (Li₂S) was introduced into a crucible formed of carbon and placed in a microwave device under an argon (Ar) atmosphere. Thereafter, the temperature was increased to 600° C. at 24° C./min in the argon (Ar) environment using the microwave device, and then heat-treated at 600° C. for 15 minutes to produce lithium sulfide (Li₂S) crystals.

### (2) Comparative Example 1

Lithium sulfide (Li₂S) crystals were produced using the same method as in Example 1, except that heat treatment was performed in the presence of a solvent without a process of drying the solvent after the synthesis reaction of lithium sulfide (Li₂S).

### (3) Comparative Example 2

Lithium sulfide (Li₂S) crystals were produced using the same method as in Example 1, except that the lithium sulfide (Li₂S) powder obtained through the drying process was placed directly inside a microwave device for heat treatment, without being introduced into a crucible formed of carbon.

### 2. Evaluation of Lithium Sulfide (Li₂S)

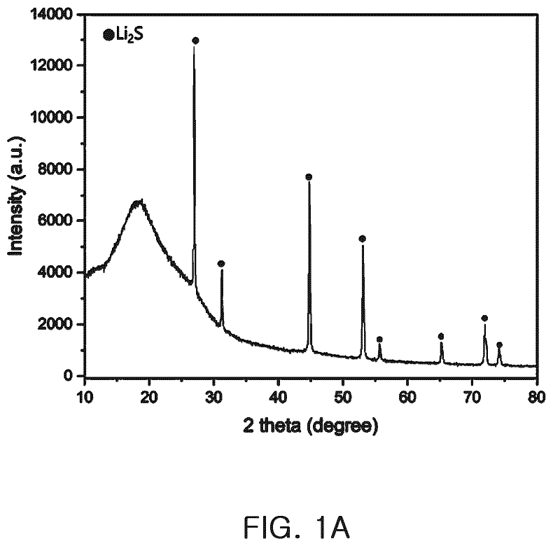

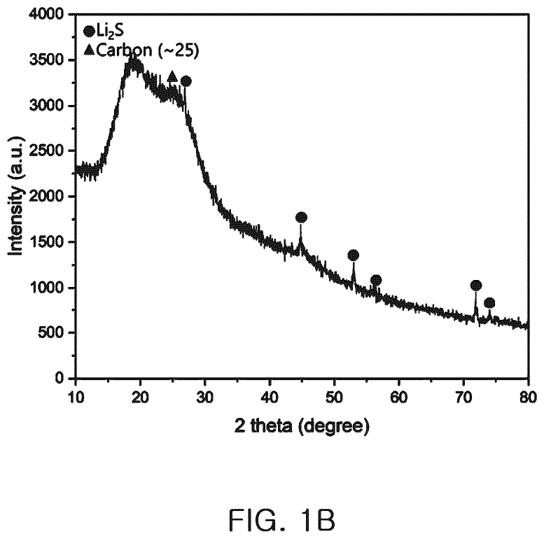

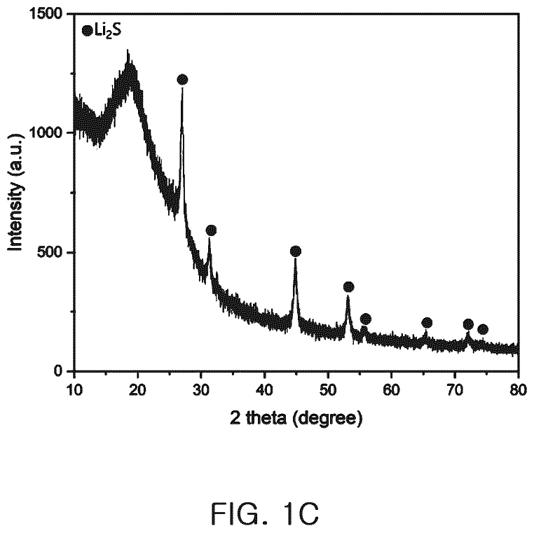

To prevent contact with the atmosphere, lithium sulfide samples from the example and comparative examples for XRD analysis were prepared inside a glove box and then analyzed using an X-ray diffraction (XRD) analyzer. The analysis results are shown in FIGS. 1A to 1C. FIG. 1A shows the analysis results for Example 1, FIG. 1B shows the analysis results for Comparative Example 1, and FIG. 1C shows the analysis results for Comparative Example 2. The XRD analysis was performed under the following conditions:
Equipment: EMPYREAN, PANalytical
Specifications: Power 4 kW
Optics: Bragg-Brentano HD, PIXcel3D Detector
Range: 10°~120°
Step size: 0.00625°
Scan speed: 0.98°/min
Wavelength: Cu Ka 1,560

Crystallinity analysis was performed based on the XRD analysis results and the Rietveld Refinement Method, and the results are shown in Table 1.

TABLE 1
Results of Crystallization Analysis

| | | Comparative | Comparative |
|---|---|---|---|
| | Example 1 | Example 1 | Example 2 |
| Crystallization | 96 | Not measurable | 34 |
| (%) | | | |

Referring to Table 1 above, Example 1, in which lithium sulfide was synthesized, dried, introduced into a crucible formed of carbon, and then microwave-heated, achieved a crystallinity of 96% despite the heat treatment for a short period of time, confirming that the produced lithium sulfide exhibited high crystallinity. This is because the crucible formed of carbon absorbed microwaves so as to be rapidly heated to transfer heat to lithium sulfide, and the lithium sulfide was then rapidly heat-treated at a high temperature, so that the crystallinity thereof was rapidly increased. Meanwhile, in the case of Comparative Example 1, which was heat-treated in the presence of a solvent without the process of drying the solvent, the crystallinity of lithium sulfide was not increased, making crystallinity measurement impossible. In addition, as shown in FIG. 1B, a carbon peak was identified in the XRD analysis results. This is because, in the process of heating the organic solvent at high temperatures rapidly by microwaves, the organic solvent was carbonized, and thus, a large amount of impurities were contained, thereby preventing the crystallinity of lithium sulfide from increasing.

In addition, in Comparative Example 2, in which lithium sulfide was heat-treated directly using microwaves without being introduced into a crucible formed of carbon, it can be seen that the crystallinity was relatively lower compared to Example 1. This is because, due to the absence of a heat transfer material that absorbs microwaves and transfers heat to the lithium sulfide, lithium sulfide was not heat-treated at high temperatures, thereby preventing a sufficient increase in crystallinity.

According to an embodiment of the present disclosure, lithium sulfide may be efficiently produced by reducing the production time.

According to an embodiment of the present disclosure, lithium sulfide with high crystallinity may be produced.

According to an embodiment of the present disclosure, lithium sulfide with high purity may be produced.

Only specific examples of implementations of certain embodiments are described. Variations, improvements and enhancements of the disclosed embodiments and other embodiments may be made based on the disclosure of this patent document.

What is claimed is:

1. A method for producing lithium sulfide for a solid electrolyte, the method comprising:
mixing lithium supply material and a sulfur supply material in a solvent to synthesize lithium sulfide;
drying the solvent to obtain lithium sulfide;
wrapping the dried lithium sulfide with a heat transfer material; and
heat-treating the lithium sulfide wrapped with the heat transfer material by applying microwaves.

2. The method of claim 1, wherein the lithium supply material includes at least one selected from the group consisting of lithium metal, lithium alkoxide, and lithium halide.

3. The method of claim 1, wherein
the sulfur supply material includes at least one selected from the group consisting of sulfur (S), hydrogen sulfide (H₂S), and metal sulfide represented by Chemical Formula 1:
MₓS
where M is at least one metal element selected from the group consisting of group 1 elements and group 2 elements, S is sulfur, and x is 1 or 2.

4. The method of claim 1, wherein the solvent includes at least one selected from the group consisting of an alcohol solvent and an ether solvent.

5. The method of claim 1, wherein the drying of the solvent is performed at a temperature of 80° C. to 200° C.

6. The method of claim 1, wherein the heat transfer material includes at least one selected from the group consisting of a carbon material and a carbide material.

7. The method of claim 6, wherein the carbon material includes at least one selected from the group consisting of graphite, carbon black, graphene, and carbon nanotube.

8. The method of claim 6, wherein the carbide material includes at least one selected from the group consisting of silicon carbide and titanium carbide.

9. The method of claim 1, wherein the wrapping of the dried lithium sulfide with the heat transfer material includes introducing the dried lithium sulfide into a container including the heat transfer material.

10. The method of claim 1, wherein
the wrapping of the dried lithium sulfide with the heat transfer material includes:
pelletizing the dried lithium sulfide; and
covering the pelletized lithium sulfide with the heat transfer material.

11. The method of claim 1, wherein the heat-treating is performed at a temperature of 300° C. to 900° C.

12. The method of claim 1, wherein the heat-treating is performed for 5 to 30 minutes.
